(19) United States
(12) Patent Application Publication
(10) Pub. No.: US 2006/0291378 A1
(43) Pub. Date: Dec. 28, 2006

(54) Communication path redundancy protection systems and methods

(75) Inventors: Michael Brotherston, Kanata (CA); Hansen Chan, Ottawa (CA)

Correspondence Address: Arnold B. Silverman;Eckert Seamans Cherin & Mellott, LLC, 44th Floor, 600 Grant Street, Pittsburgh, PA, 15219, US

(73) Assignee: Alcatel, Paris (FR)

(21) Appl. No.: 11/168,644

(22) Filed: Jun. 28, 2005

(51) Int. Cl. H04J 3/14

(52) U.S. Cl. 370/221

(57) ABSTRACT

Communication path redundancy protection systems and methods are disclosed. Multiple communication interfaces having a common address support communications on respective communication paths. One of the interfaces or communication paths is selected as an active interface or path for transferring communication traffic. In the event of a fault associated with the active interface or path, another one of the interfaces or paths is selected to become active. The common address allows redundant interfaces to appear as a single interface to other communication equipment, whereas the multiple interfaces provide redundant path protection using a single piece of communication equipment. When embodiments of the invention are implemented in a gateway router of a core communication network, for example, activity switches between redundant access paths have no effect on routing in the core network.

### Field of the Invention

This invention relates generally to communications and, in particular, to providing redundancy protection for communication paths in a communication system.

### BACKGROUND

Protection of communication systems to provide reliable service and high availability is an ongoing challenge for operators and service providers. Equipment redundancy is one example of a common protection scheme. In an equipment redundancy protection system, groups of components which are capable of performing the same functions, or at least common protected functions, are deployed. Only one redundant component of a redundancy group is normally relied upon to perform protected functions at any time, and is generally referred to as the “active” component. Other components of a redundancy group, one or more “standby” components, are typically idle until a failure of the active component is detected. In this event, activity is switched from the failed active component to a standby component, which takes over protected functions of the failed active component.

One known redundancy protection scheme is Virtual Router Redundancy Protocol (VRRP). VRRP has been used in best-effort Internet Protocol (IP) networks to provide redundancy protection for gateway IP routers. In one common type of installation, a gateway IP router is connected to a default static Local Area Network (LAN) which includes IP hosts, and provides the IP hosts with access to an IP network.

VRRP applies equipment redundancy principles to routers and thus requires two routers to provide redundancy. However, despite the extra investment in a second router for every gateway router which is to be protected, an activity switch in VRRP affects routing topology in the backbone IP network, thereby requiring network re-convergence. This can result in several minutes of communication traffic disruption before full service restoration. A service interruption could last 15-30 minutes, or even longer, depending on the size and topology of the IP network.

Thus, although VRRP provides a level of protection against gateway router failure, there remains a significant challenge of how to offer high availability IP services. Service interruption recovery times on the order of minutes are not feasible for IP networks in which mission critical and real-time services such as Voice over IP (VoIP), video services, and web commerce services are to be offered.

### SUMMARY OF THE INVENTION

Embodiments of the invention provide communication path redundancy protection at an IP gateway for applications, such as VoIP and video applications, having high network availability constraints.

A Single Router Redundancy Protocol (SRRP) in accordance with one embodiment of the present invention provides Layer 3 interface protection, and thus communication path protection, by using two interfaces with the same address. These interfaces appear to other devices as a single interface. One interface is active and forwards Layer 3 traffic. The other is inactive, operating in a standby mode to passively discard all traffic. When a fault is detected on the active interface, the standby interface takes activity and continues to forward traffic.

According to one aspect of the invention, an apparatus for providing communication path redundancy protection in a communication system includes a plurality of interfaces configured to support communications with a remote system on a plurality of respective communication paths. The plurality of interfaces have a common address. The apparatus also includes a controller configured to select an interface of the plurality of interfaces as an active interface for exchanging communication traffic with the remote system.

The controller may be further configured to select a new active interface from the plurality of interfaces responsive to a fault associated with the active interface or the communication path supported by the active interface.

Fault detection by the controller may be based on monitoring of at least one of: a status of a port associated with the communication path supported by the active interface, traffic communicated on the communication path, and other information communicated on the communication path.

In one embodiment, the apparatus is provided in communication equipment associated with an address which is used in a communication network for communicating traffic between the communication network and the remote system. The address remains usable for communicating traffic between the communication network and the remote system after a new active interface is selected.

The interfaces may include physical interfaces or logical interfaces, and in one embodiment the plurality of interfaces comprises Layer 3 interfaces or IP interfaces.

An example of the remote system is a Local Area Network (LAN) in which a plurality of host systems are operatively coupled. In this case, the common address may be a default address used by the host systems to transfer communication traffic to external systems outside the LAN.

The apparatus may also include a configuration interface for allowing configuration of the common address for the plurality of interfaces.

In a communication system, the apparatus may be implemented at a gateway of a first communication network which provides a second communication network with access to the first communication network. The gateway may be associated with an address which is used in the first communication network for communicating traffic between the first communication network and the second communication network. The address remains usable for communicating traffic between the first communication network and the second communication network even after a new active interface is selected responsive to a fault on an active interface or the communication path it supports.

According to another aspect of the invention, a communication network gateway for providing access to a communication network from an access network includes a configuration interface and a controller. The configuration interface allows configuration of a communication path redundancy group, the communication path redundancy group comprising a plurality of communication paths between the gateway and the access network, the plurality of communication paths being supported by respective communication interfaces having a common address associated with the access network. The controller is configured to control the plurality of communication paths to designate one of the plurality of communication paths as an active communication path for transfer of communication traffic between the communication network and the access network.

The common address may be a default gateway address used by components of the access network to access the communication network.

In one embodiment, the gateway is associated with an address used in the communication network for communications with the access network. The address of the gateway is preferably independent of the active communication path.

The controller may be further configured to detect a fault associated with the active communication path, and to designate another communication path of the redundancy group as the active communication path responsive to the detection.

A method of providing communication path redundancy in a communication system, according to another embodiment of the invention, includes configuring, as a communication path redundancy group, a plurality of communication paths through respective communication interfaces having a common address, selecting one of the plurality of communication paths as an active communication path for transfer of communication traffic, and selecting another one of the plurality of communication paths as the active communication path responsive to a fault associated with the active communication path.

The method may also include monitoring at least the active communication path. Another one of the plurality of communication paths is then selected responsive to a fault detected during the monitoring.

Where the communication paths comprise communication paths between a communication network gateway and an access network, configuring may involve configuring as the common address a default gateway address used in the access network.

The method may also include configuring a further communication interface with an address used in the communication network to transfer communication traffic to the access network. The communication network address is unaffected by the operation of selecting another one of the plurality of communication paths.

In one embodiment, a machine-readable medium stores instructions which when executed enable the method to be performed. The instructions include instructions which when executed allow the communication path redundancy group to be configured, and instructions which when executed perform the operations of selecting one of the plurality of communication paths and selecting another one of the plurality of communication paths.

Other aspects and features of the present invention will become apparent to those ordinarily skilled in the art upon review of the following description of specific illustrative embodiments thereof.

### BRIEF DESCRIPTION OF THE DRAWINGS

Examples of embodiments of the invention will now be described in greater detail with reference to the accompanying drawings, in which:

FIG. 1 is a block diagram of a communication system implementing redundant gateway routers;

FIG. 2 is a block diagram of a communication system in which embodiments of the invention may be implemented;

FIG. 3 is a block diagram of a communication network element implementing a redundancy protection system according to an embodiment of the invention; and

FIG. 4 is a flow diagram of a method of an embodiment of the invention.

### DETAILED DESCRIPTION OF PREFERRED EMBODIMENTS

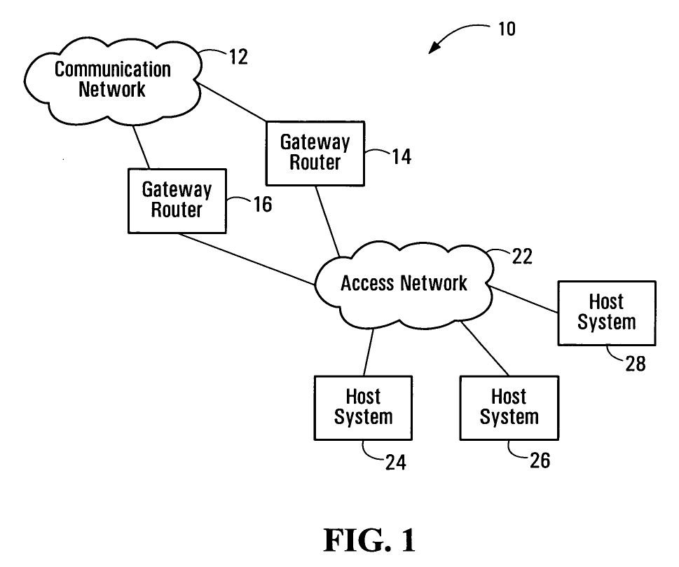

FIG. 1 is a block diagram of a communication system implementing redundant gateway routers. The communication system 10 includes a communication network 12, redundant gateway routers 14, 16, an access network 22, and host systems 24, 26, 28. In a typical VRRP installation, the communication network 12 is an IP network, the gateway routers 14, 16 are IP routers, the access network 22 is a LAN, and the host systems 24, 26, 28 are IP hosts. Those skilled in the art will be familiar with the components shown in FIG. 1, which are therefore described only briefly herein.

Dynamic IP routing has been the norm of production network deployment in so-called core networks such as the communication network 12. The access network 22 connected to host systems 24, 26, 28, however, has typically remained a static and default routing environment.

This scenario is very common in service provider networks. In a service provider network, the host systems 24, 26, 28 may be IP hosts such as devices in a broadband communication service subscriber's home, including personal computers (PCs), set-top boxes, and/or IP telephones, VoIP/video backend office equipment including media gateways, softswitches, video encoders and/or middleware, or Internet web servers in data centers.

Examples of the access network 22 are an Ethernet network and an Asynchronous Transfer Mode (ATM) network employing bridged Protocol Data Units (PDUs).

In a non-redundant system in which only one of the routers 14, 16 is provided, the access network 12 aggregates all traffic from the host systems 24, 26, 28 and hands off to the gateway router. The gateway router is the default gateway router for all of the host systems 24, 26, 28. Depending on the network applications, the number of host systems 24, 26, 28 can range from a few to tens of thousands.

The default gateway router in a non-redundant system is the only path for the host systems 24, 26, 28 to access the communication network 12 and for the communication network 12, and other systems enabled for communications through the communication network 12, to access the host systems 24, 26, 28. To ensure high availability for services offered or used by the host systems 24, 26, 28, comprehensive protection for the default gateway router is highly desirable.

One common approach to gateway router protection in IP networks is to provide equipment redundancy protection by deploying a pair of default gateway routers 14, 16 as shown in FIG. 1, with two exit links from the access network 22. In this approach, the two routers 14, 16 provide redundancy support for each other, and the two exit links provide path diversity and protection for access communications between the communication network 12 and the access network 22.

This approach works well if the host systems attached to the access network 22 run a dynamic routing protocol such as Open Shortest Path First (OSPF) or Routing Information Protocol (RIP). Each host system 24, 26, 28 can have a routing adjacency to each default gateway router 14, 16. The routing adjacencies may be managed so that one gateway router is active and the other is in a standby mode, or in a loadsharing mode in which both gateway routers 14, 16 are operative to process communication traffic.

However, dynamic routing presents several challenges in the access network 22. For instance, not all host systems 24, 26, 28 can typically run dynamic routing protocols. While some high-end workstations or PCs might have the processing cycles to run dynamic routing protocols, many low-end IP host devices, such as telephones and set-top boxes, do not. Even if all host systems can run dynamic routing protocols, it is very demanding on the default gateway routers 14, 16 to have adjacencies with hundreds or thousands host systems. In addition, even if the default gateway routers 14, 16 can handle the required number of adjacencies, the number of routing nodes in the communication network 12 is increased significantly by providing pairs of redundant edge routers instead of single routers. This increases the number of routes and thus convergence times in the communication network 22 in order to support access for host systems in external access networks such as 22.

Dynamic routing protocols, while possible, thus tend not to be feasible in practice.

The Internet Engineering Task Force (IETF) Request For Comments (RFC) 3768 specifies VRRP. VRRP is designed to eliminate the single point of failure inherent in a default routing environment, but assumes the use of a two-router architecture as shown in FIG. 1. It enables one router to assume the gateway function of another router should the other router fail.

VRRP is an election protocol typically run between two default gateway routers connected to the same IP subnet, typically an Ethernet LAN. Details of VRRP can be found in the above-referenced RFC-3768 and therefore VRRP is described only briefly herein.

Referring again to FIG. 1, VRRP messages are exchanged via the access network 22. For an Ethernet implementation, each gateway router 14, 16 has a well-known virtual Media Access Control (MAC) address assigned to it. This virtual router MAC address is used in all periodic VRRP advertisement messages sent by a master gateway router of the pair 14, 16 to enable bridge learning in the access network 22.

The IP hosts only know about one IP default gateway router address and will try to learn the MAC address of that default gateway router. The default IP gateway router address is normally manually configured at each host system 24, 26, 28, and the virtual MAC address is learned through Address Resolution Protocol (ARP). IP packets are then sent using the virtual MAC address as the destination address in an Ethernet header. Ethernet frames generated by the host systems 24, 26, 28 are sent to the master gateway router of the pair 14, 16 through an Ethernet switch (not shown) in the access network 22, which learns the whereabouts of the master gateway router through ARP.

VRRP was designed when IP networks were expected to deliver only best-effort types of service. Mission-critical services with “5-nines” availability requirements were beyond the horizon at that time. Today, however, IP networks are deployed to deliver services such as voice, video, and IP Virtual Private Network (VPN) premium data, which require high network availability. Many of these services make extensive use of application servers attached to a LAN or other access network. Common application servers include VoIP softswitches and session border controllers, Video On Demand (VOD) servers and middleware, and other IP Multimedia Subsystem (IMS) media servers. These servers are the central point in a communication system to provide services for millions of subscribers. Hence a 5-nines availability for IP network access through access networks is critical.

Although VRRP provides redundancy protection for access communications, it involves doubling gateway router infrastructure. It also cannot ensure 5-nines or comparable availability due to its service recovery speed for host systems in an access network and network convergence speed in the backbone network.

Service recovery tends to be slow for VRRP because data traffic from host systems is sent to a master gateway router only. If the master gateway router fails, then any IP services being offered or used by the host systems 24, 26, 28 will stop until VRRP recovers. VRRP recovery requires a backup gateway router to detect the failure of the master gateway router, to transition itself into master state, and to advise the Ethernet switch and/or other components of the access network 22 that it is now the master router. Typically, full service restoration takes anywhere from 5 to 10 seconds before the backup gateway router becomes fully functional as a master router to resume packet forwarding and MAC forwarding tables in the access network 22 are updated.

While all data traffic from the access network 22 is normally sent only to the master gateway router, communication traffic from the communication network 12 may be sent to the master gateway router or the backup gateway router, depending on the location of senders and network topology. Routers (not shown) in the core of the communication network 12 will choose to send to the master gateway router or the backup gateway router of the pair 14, 16 depending on the link cost or metric assigned to IP routing, for example.

In this case, detection of a failure of the master gateway router by core routers may take several minutes. Unlike the backup router which can usually discover master gateway router failure within a few seconds according to VRRP, core routers have no way of quickly detecting a failure of the master gateway router, and instead must rely on routing protocols such as OSPF or a Border Gateway Protocol (BGP), illustratively BGP version 4 (BGP4), to detect that the routing adjacency between the master and backup gateway routers is down. In the meantime, core routers may continue to send traffic to the failed master router as per their current routing tables. Therefore, at least a subset of source nodes would not be able to communicate with the host systems 24, 26, 28 in the access network 22. If the host system 24, 26, 28 are voice, video, or media servers, for example, then the subset of subscribers would not be able to obtain subscribed services.

When the core routers finally detect that the master gateway router has failed, new routing updates are provided to other routers so that the whole communication network 12 can converge completely, after which all communication traffic is sent to the new master gateway router. Only at this point are host system services in the access network 22 completely restored. Depending on network size and topology, the complete routing convergence in the communication network 12 can take anywhere from 5 to 30 minutes, or in some cases even longer.

FIG. 1 clearly shows that the number of gateway routers in the communication network 12 is doubled in order to provide redundancy protection using VRRP. The number of addresses required for gateway routers is also doubled, as is the number of routing adjacencies required at the edge of the communication network 12. These infrastructure demands increase both capital and operating expenditures required to manage the communication network 12.

In accordance with an embodiment of the invention, the redundancy protection model is changed to achieve high network and service availability. A redundancy protection scheme referred to herein as SRRP provides for faster recovery than conventional protection techniques and thus higher availability for mission-critical and real-time services.

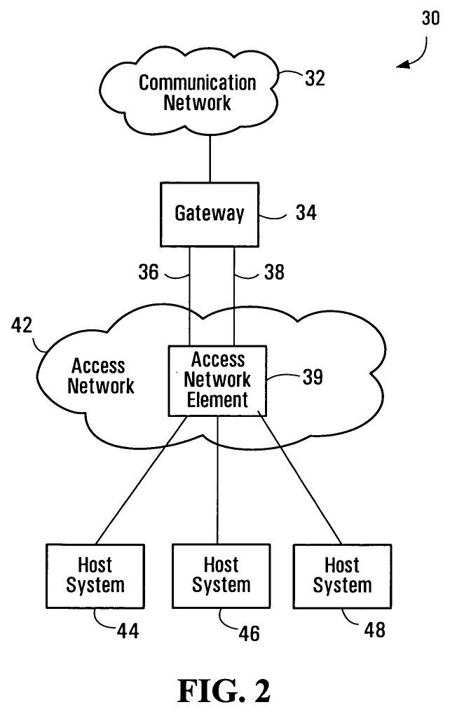

FIG. 2 is a block diagram of a communication system in which embodiments of the invention may be implemented. The communication system 30 includes a communication network 32, a gateway 34, an access network 42 operatively coupled to the communication network 32 through the gateway 34, the access network element 39, and exit links or communication paths 36, 38, and host systems 44, 46, 48 in the access network 42.

Although many communication networks 32, gateways 34, and access networks 42 may be provided in a communication system, only one example of each type of system has been shown in FIG. 2 to avoid congestion. More or fewer than the three host systems 44, 46, 48 may also be provided in an access network 42, and the networks 32, 42 may include additional components which have not been explicitly shown in FIG. 2. It should therefore be appreciated that the system of FIG. 2, as well as the contents of subsequent drawings, are intended solely for illustrative purposes, and that the present invention is in no way limited to the particular example embodiments as shown in the drawings and specifically described herein.

The communication network 32 represents a backbone network, illustratively the Internet, through which other systems such as subscriber terminals (not shown) can communicate with the host systems 44, 46, 48 in the access network 42. The access network 42, in at least some implementations, will be a less expansive network than the communication network 32. Through the access network 42, the host systems 44, 46, 48 communicate with each other and with the communication network 32.

Those skilled in the art will be familiar with many different types of communication network which may be used to implement the networks 32, 42. For example, in one embodiment, the communication network 32 is an IP network, and the access network 42 is an IP subnet implemented as an Ethernet LAN with IP hosts as the host systems 44, 46, 48. The present invention, however, is not limited to this or any other specific implementation. Embodiments of the invention may be used to provide redundancy protection in conjunction with other types of network, equipment, and/or communication protocols, including those which are currently known and others which may be subsequently developed.

The specific types, structures, and operation of the networks 32, 42 may thus vary between embodiments of the invention, and particular implementation details may be different for different networks. Accordingly, although some embodiments of the invention are described herein with reference to examples of the networks 32, 42, a person skilled in the art will be enabled, based on the present disclosure, to put principles of the invention into practice in any of a number of different types of network.

The gateway 34 is a border or edge network element of the communication network 32 which provides access to the communication network 32 for external systems, such as the host systems 44, 46, 48. In one embodiment, the gateway 34 is an IP gateway router.

The access network element 39 performs similar edge functions for the access network 42. In one embodiment, the access network element 39 is an Ethernet switch which transfers IP traffic between the host systems 44, 46 ,48 and the gateway 34. The access network element 39 is an example of equipment of the access network 42 through which the host systems 44, 46, 48 may be operatively coupled to the communication network 32, and may itself be directly (as shown) or indirectly connected to the gateway 34 through other equipment.

PCs and application servers are illustrative examples of the host systems 44, 46, 48. The host systems 44, 46, 48 may be configured in a static default IP environment in an Ethernet LAN domain of the access network 42, for example. This type of arrangement is common in an Application Service Provider (ASP) Point Of Presence (POP) or data center, an installation for a so-called “triple play” provider of Internet, telephone, and television services, and/or wireless/IMS service provider systems.

In operation, communications between the host systems 44, 46, 48 and the gateway 34 may be substantially similar to previous techniques, from the perspective of the host systems 44, 46, 48. For example, the host systems 44, 46, 48 may send all IP traffic to one default gateway and one MAC address through the access network element 39. According to an embodiment of the invention, SRRP provides redundancy protection with fast recovery and high availability, using one gateway 34, without affecting the host systems 44, 46, 48.

The access network element 39 supports two communication paths 36, 38 between the access network 42 and the communication network 32. In an IP and Ethernet-based implementation, the paths 36, 38 may be configured to share one IP address on two IP interfaces at the gateway 34 and one virtual MAC address for the two IP interfaces. Thus, when the network element 39 receives IP traffic from the host systems 44, 46, 48 and forwards the received traffic to the default gateway address, the traffic is actually transmitted over both paths 36, 38.

Although SRRP is implemented at the gateway 34 in one embodiment, the access network element 39 need not have any knowledge that SRRP is enabled on the gateway 34. The access network element 39 may simply forward traffic to gateway 34 without regard to the contents of the traffic, as in the case of a “dumb” bridge or switch.

At the gateway 34, only one of the paths is configured as an active path to forward traffic into the network 32, and the other path is configured as a standby path, and drops received traffic.

Configuring redundant communication paths with common addresses reduces SRRP to an internal mechanism, such that the operation of SRRP on the gateway 34 is totally transparent to the access network element 39, to the host systems 44, 46, 48, and also to core routers in the communication network 32. This provides for interoperability between a gateway router such as 34 which implements SRRP and other routers and equipment which do not.

The manner in which communication path faults or failures are detected may be dependent to some degree on the type of the redundant communication paths. For example, communication path failure detection may be based on Synchronous Optical Network/Synchronous Digital Hierarchy (SONET/SDH) layer failures, ATM layer failures detected through Operation, Administration and Maintenance (OAM) techniques, or Ethernet physical layer or MAC layer failures.

When a failure is detected on an active path of the pair 36, 38, the gateway 34 forwards all traffic on the standby path. As the recovery mechanism is internal to the gateway 34, communications with the access network 42 can be resumed within a recovery time on the order of seconds rather than minutes.

Also, since communication path redundancy is provided by a single gateway 34, failure of an active communication path does not have any effect on routing in the core network 32. Core routers can continue to forward communication traffic to the gateway 34 regardless of which path 36, 38 is currently active. Also, since the same address information is used for both paths 36, 38 at the gateway 34, the access network element 39 is not required to determine a new address for the standby path in the event of an activity switch. In contrast, as described above, recovery from a failure of the master gateway router in a VRRP implementation requires both core network convergence and identification of a backup gateway router, which can take substantially longer.

In one embodiment, SRRP is configured at the gateway 34 by an operator. For an IP and Ethernet-based system, the operator may configure a primary interface and a protecting interface, a virtual MAC address for both interfaces, and a single IP address for both interfaces. IP static routes may also be configured on both interfaces and distributed in the communication network 32 via Interior Gateway Protocol (IGP) or BGP4 to advertise reachability of the host systems 44, 46, 48 through the gateway 34.

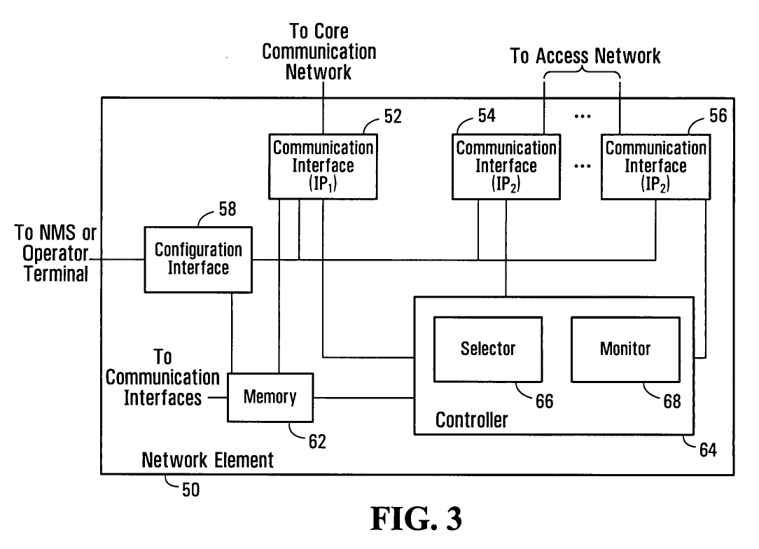

FIG. 3 is a block diagram of a communication network element implementing a redundancy protection system according to an embodiment of the invention. The network element 50 may be implemented, for example, as a gateway such as the gateway 34 (FIG. 2) to provide access to a communication network, as a network element such as 39 (FIG. 2) of an access network, or possibly both, depending upon the degree of redundancy to be provided in a communication system. The network element 50 might also or instead be implemented in a communication network core as opposed to its edge, although other fault protection mechanisms such as dynamic routing would normally be available in a network core. The network element 50 may be particularly useful where other protection mechanisms are not feasible, in a static IP environment for instance.

As shown in FIG. 3, the network element 50 includes communication interfaces 52, 54, 56, a configuration interface 58 operatively coupled to the communication interfaces 52, 54, 56, a memory 62 operatively coupled to the configuration interface 58 and to the communication interfaces 52, 54, 56, and a controller 64 operatively coupled to the configuration interface 58, to the communication interfaces 52, 54, 56, and to the memory 62. The controller 64 includes a selector 66 and a monitor 68.

It should be appreciated that a network element may include further, fewer, or different components than those explicitly shown in FIG. 3, which may be operatively coupled in a similar or different manner. In addition, the particular structure, implementation, and operation of the components shown in FIG. 3 may vary depending upon the communication network(s) in conjunction with which the network element 50 is to operate.

The communication interfaces 52, 54, 56 represent resources which support communications with other systems or devices. These resources may include physical resources, such as network interface cards, input/output (I/O) cards, and router ports connected to different physical lines, logical resources such as ATM virtual channels, or some combination of physical and logical resources. Thus, the interfaces 52, 54, 56 may be considered physical interfaces and/or logical interfaces. The specific structure and operation of the interfaces 52, 54, 56 may depend on such factors as the types of communication path which may be established with remote systems or devices, and in the case of the redundant interfaces 54, 56, the level of protection to be provided.

In the illustrative example network element 50, the communication interface 52 supports communications with a core communication network, and the communication interfaces 54, 56 support redundant communication paths to an access network. Although shown as separate blocks in FIG. 3, the interfaces 54, 56 may share at least some physical components. For a relatively high level of protection, it may be desirable to provide separate physical components for each of the communication interfaces 54, 56. However, a measure of fault protection may be provided by configuring different logical communication paths using common, shared physical components.

The configuration interface 58 allows the interfaces 52, 54, 56 to be configured using local equipment such as an operator terminal for instance. Some types of network element and configuration interface may also or instead allow remote configuration of the interfaces 52, 54, 56, such as through a Network Management System (NMS).

The manner of configuration of the interfaces 52, 54, 56 would also be dependent at least to some extent upon the types of the interfaces 52, 54, 56, the types of communication paths supported by the interfaces, and control or management mechanisms in place for the communication network in which the network element 50 is to be deployed. In one embodiment, an operator enters configuration information such as address information at a terminal, and this configuration information is received through the configuration interface 58 and stored in the memory 62.

Any of many different types of memory device may be used to implement the memory 62. The memory 62 may include multiple memory devices of the same or different types. Solid state memory devices, disk drives, and other memory devices for use with fixed, movable, or even removable storage media, are all examples of the types of device which the memory 62 may include.

The controller 64, including the selector 66 and the monitor 68, may be implemented in hardware, in software stored in the memory 62 for execution by a processor, or some combination thereof. Examples of processors which may be used to execute control software include microprocessors, microcontrollers, Application Specific Integrated Circuits (ASICs), Digital Signal Processors (DSPs), Programmable Logic Devices (PLDs), and Field Programmable Gate Arrays (FPGAs). In one embodiment, the controller 64 is implemented using a microprocessor on a control card in communication equipment.

For the purposes of the present invention, the controller 64 performs various functions to control redundant communication paths. The controller 64 may also perform functions for controlling other operations of the network element 50, as illustrated in FIG. 3 by the connection between the controller 64 and the communication interface 52. A control card processor, for example, might not be dedicated to redundancy control functions.

The network element 50 provides redundancy protection for access network communications. The communication interfaces 54, 56 are configured through the configuration interface 58 to support communications with the access network, or more generally a remote system, on respective communication paths. In accordance with an aspect of the invention, the redundant interfaces 54, 56 use a common address. The common address may include a common IP address IP₂ shown in FIG. 3. As noted above, the communication interfaces 54, 56 may also or instead be configured to share a common virtual MAC address where the access network is an Ethernet network.

In one embodiment, a communication interface of a redundancy group is configured by entering configuration information through the configuration interface 58. A redundancy group may then be created, for example, by adding other interfaces, and thus their supported communication paths, to the group.

A group of redundant paths may be configured, for example, by specifying a virtual MAC address, an IP address, and other configurables for communication interfaces and then configuring distinct redundant paths for the interfaces, with or without the option of specifying an active path. In one embodiment, interfaces are created by specifying a path and a redundant path, followed by configurables, including IP address and MAC address.

Redundancy group creation and membership may be managed in various ways. A redundancy group may be created when its first interface is configured by an operator. For instance, the operator may specify that a primary interface/path is being configured for a redundancy group. Membership in a redundancy group could be indicated using a flag, group name, or other field in configuration information, or by identifying redundant interfaces and/or paths in a group membership list. In one embodiment, the configuration process is simplified by automatically porting any common group configuration information such as the common address into configuration information for new interfaces as those are added to the redundancy group. This avoids having an operator re-enter identical configuration information for every interface and path in a group, thereby both saving configuration time and avoiding potential data entry errors.

Once a redundancy group has been configured with at least two interfaces, the selector 66 selects an active interface or communication path for exchanging communication traffic with the access network. The selection of an active interface or path may be made based on configuration information, an explicit selection made by a user, or as described below, based on an output from the monitor 68. During redundancy group configuration, an operator may specify that a particular interface, the first interface configured for instance, is to be a primary interface for the redundancy group. The primary interface may then be selected by the selector 66 as the active interface whenever it is operational. An operator may also manually invoke an activity switch and/or force selection of a particular interface or path as the active interface or path in some embodiments.

Various mechanisms may be implemented for controlling activity within a redundancy group. The communication interfaces 54, 56 may only be active to perform communication operations when enabled by a control signal from the controller 64, for example. In this case, the selector 66 may assert an enable signal for an active interface, and thus an active communication path, unless or until activity is to be switched. Only the enabled communication interface is then operative to handle communication traffic. In another possible embodiment, activity is controlled on the basis of flags or other indicators stored with configuration information in the memory 62. Each communication interface 54, 56 may then access the memory 62 to determine whether it is currently active.

Although the network element 50 may receive communication traffic on multiple redundant interfaces, since all interfaces in the group have the same address, only the active interface handles the communication traffic. In FIG. 3, only the active one of the interfaces 54, 56 passes communication traffic into or out of the core network through the communication interface 52, and possibly other communication traffic processing components (not shown). Any standby interfaces may simply drop or discard received communication traffic.

The monitor 68 monitors the communication paths supported by the interfaces 54, 56, or at least the active communication path, to detect faults. For instance, faults may be detected based on monitoring of one or more of physical and/or logical port statuses, communication traffic communicated on a communication path, and other information communicated on a communication path. SONET/ATM faults, for example, may be detected on the basis of either or both of ATM port status and OAM traffic such as Alarm Indication Signal (AIS) or Remote Defect Indication (RDI) cells.

In the event of a fault detection by the monitor 68, the selector 66 selects a new active interface from the interfaces 54, 56. According to one embodiment, the interfaces 54, 56 are Layer 3 interfaces, and Layer 3 traffic is switched from a faulted interface or path to a standby interface and path when a fault associated with the active path is detected.

Communication path redundancy in accordance with embodiments of the invention may be designed to operate in conjunction with other protection mechanisms, such as on top of Line Card Redundancy (LCR)/Equipment Protection Switching (EPS), and SONET Automatic Protection Switching (APS). For example, the controller 64 may be designed so that port switches caused by APS do not cause an interface/path activity switch, whereas an interruption at the ATM Virtual Channel (VC) level results in an activity switch.

For an Ethernet interface redundancy protection group, Link Aggregation Groups (LAGs) preferably reside under the protection group. A LAG uses two or more physical ports to aggregate IP traffic. If redundant interfaces or paths include ports which belong to two distinct LAGs, then activity need not be switched as long as a LAG in the active interface or path remains operative, that is, at least one port is in an operative state. The selector 66 may then switch activity only when the monitor 68 detects that the entire LAG is in a fault state.

The example network element 50 is shown in FIG. 3 as a gateway network element, in which the communication interface 52 is associated with an address IP₁ in a core communication network, and the communication interfaces 54, 56 are associated with the same common address IP₂ in an access network. The address IP₁ is used in the core communication network for communicating traffic with the access network, and is independent of the particular one of the communication interfaces 54, 56 which is active at any time. Thus, the address IP₁ remains usable for communicating traffic between the core communication network and the access network even if an activity switch is made in the network element 50.

This communication network address independence feature provides the substantial benefit of allowing implementation of redundant access path protection with a single gateway router, for example. In an IP-based core communication network, IP routing tables in the core network are not affected by an access path activity switch, and thus an access path activity switch does not require any core network convergence or routing table updates.

Depending on the architecture layer of the communication interfaces 54, 56 and lower layers involved in the communication paths, common configuration at the lower layers can provide similar advantages in terms of recovery operations for access communication. Consider the example of a core IP network and an Ethernet LAN with IP hosts as the access network. If the communication interfaces 54, 56 were configured with a common virtual MAC address, then ARP tables which map IP addresses to MAC addresses would require no updates in the event of an activity switch at the network element 50.

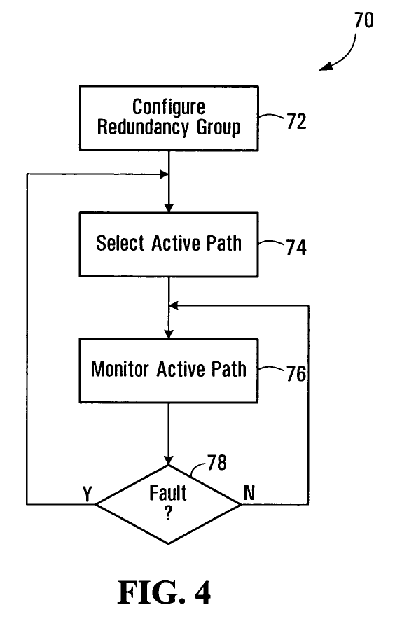

Embodiments of the invention have been described above primarily in the context of systems and apparatus. FIG. 4 is a flow diagram of a method according to another embodiment of the invention. The method 70 begins at 72 with configuring a communication path redundancy group. This may involve configuring interfaces and paths such as static IP routes, for example, as described above. The redundancy group includes multiple communication paths through respective communication interfaces having a common address.

One of the communication paths is selected at 74 as an active communication path for transfer of communication traffic. At 76, at least the active communication path is monitored for one or more fault conditions. Monitoring may be an ongoing process which continues until a fault is detected at 78. Responsive to detection of a fault, another one of the communication paths is selected as the active communication path at 74.

The method 70 represents an example of a method according to one embodiment of the invention. Other embodiments may be implemented with further or fewer steps than those explicitly shown in FIG. 4, which may be performed in a similar or different order. Some potential variations of the method 70 will be evident from the foregoing system and apparatus descriptions, and others may be apparent to those skilled in the art.

A new redundancy and restoration paradigm are thereby provided by embodiments of the invention. Communication interfaces, illustratively Layer 3 interfaces such as IP interfaces, are configured as a redundancy group with a common address and thus appear as a single interface to remote systems which use that common address. Only one of the interfaces is active at any time to handle communication traffic. For example, the active interface may forward communication traffic, while the inactive interface(s) will discard all received traffic.

By configuring multiple paths on a single piece of communication equipment such as a gateway router which exchanges traffic between a core network and an access network, communications in the core network are not affected by activity switches within the redundancy group. In an IP core network for instance, IP routing tables in the network are unaffected by activity switches. From the perspective of routing, a redundancy group remains up as long as one interface and path are operational.

Less intensive fault recovery operations, relative to those required in VRRP, for example, provide high availability for IP services, such as in a static default routing environment. A single router architecture as disclosed herein can provide higher availability for IP services, with potential sub-second fault recovery times versus minutes in the case of VRRP. In conjunction with SRRP, servers such as video or VoIP servers can provide virtually non-stop multimedia service to subscribers.

SRRP also enables cost savings for providers and network administrators. In a gateway router implementation, for example, capital expenditure is reduced in that only one gateway router is required instead of the dual routers in VRRP. Operating expenses can also be reduced, as the number of routers, the number of core (and access) network addresses required for infrastructure, and the number of core network physical links, is halved relative to VRRP.

What has been described is merely illustrative of the application of principles of embodiments of the invention. Other arrangements and methods can be implemented by those skilled in the art without departing from the scope of the present invention.

For example, the actual implementation of embodiments of the invention may vary between types of equipment, networks, and communications. The invention is in no way limited to bridged encapsulation over cell-relay and Ethernet encapsulated interfaces, or any other illustrative examples which have been described above.

An embodiment of the invention might provide high availability corporate IP access for Enterprise service to hosts in an enterprise site for instance. An Ethernet switch in such a site could be connected to a gateway router in a corporate IP network through an ATM network. To provide redundancy protection, two ATM VCs could be provisioned between the switch and router.

Another possible application of embodiments of the invention would be to provide high availability Asymmetric Digital Subscriber Line (ADSL) broadband service. A DSL Access Multiplexer (DSLAM), such as an ATM-based DSLAM or an Ethernet-based DSLAM, may have two access network or trunk interfaces, and SRRP could be implemented at an edge router.

High availability application data centers may also benefit from communication path redundancy protection as disclosed herein. Service providers are continually planning for new value-added services for their subscribers. Many new services rely on intelligent applications running over high-end servers. Examples include video middleware and Dynamic Host Configuration Protocol (DHCP) policy servers for triple play services, and softswitches and application/media servers for next generation IP Multimedia/VoIP services. In these examples, tens of thousands, if not millions, of customers rely on uninterrupted access to an application data center to obtain such services. Perhaps the most common type of interconnection between network routers and servers is Ethernet, with a static default LAN network, as described above.

Mobile IMS operators, for example, offer their subscribers value-added services including VoIP, video telephony, presence, instant messaging, and push-to-talk/video. These services require reliable access to corresponding servers by subscribers. A carrier-class router with SRRP can provide such access.

A broadband service provider's challenge is no less daunting. Their VoIP and video services similarly require constant secured and reliable access to their backend offices with video headend servers, voice softswitches, and media gateways. A broadband service provider offering video and VoIP services usually finds subscribers have a much higher expectation on reliability than on high speed Internet service. SRRP may be used to provide the level of reliability and availability suitable for offering these types of service.

Thus, the invention is in no way limited to any particular type of network or topology.

It should also be appreciated that a redundancy group may include more than a pair of interfaces/paths. A redundancy group may include two or more interfaces/paths.

In addition, although described primarily in the context of methods and systems, other implementations of the invention are also contemplated, as instructions stored on a machine-readable medium or a data structure for storing configuration information on such a medium, for example.

We claim:

1. Apparatus for providing communication path redundancy protection in a communication system, the apparatus comprising:
a plurality of interfaces configured to support communications with a remote system on a plurality of respective communication paths, the plurality of interfaces having a common address; and
a controller configured to select an interface of the plurality of interfaces as an active interface for exchanging communication traffic with the remote system.

2. The apparatus of claim 1, wherein the controller is further configured to select a new active interface from the plurality of interfaces responsive to a fault associated with the active interface or the communication path supported by the active interface.

3. The apparatus of claim 2, wherein the controller is configured to detect a fault based on monitoring of at least one of: a status of a port associated with the communication path supported by the active interface, traffic communicated on the communication path, and other information communicated on the communication path.

4. The apparatus of claim 2, wherein the apparatus comprises communication equipment associated with an address in a communication network, the address being used in the communication network for communicating traffic between the communication network and the remote system and remaining usable for communicating traffic between the communication network and the remote system after the new active interface is selected.

5. The apparatus of claim 1, wherein the plurality of interfaces comprises physical interfaces or logical interfaces.

6. The apparatus of claim 1, wherein the plurality of interfaces comprises Layer 3 interfaces or Internet Protocol (IP) interfaces.

7. The apparatus of claim 1, wherein the remote system comprises a Local Area Network (LAN) in which a plurality of host systems are operatively coupled, the common address comprising a default address used by the plurality of host systems to transfer communication traffic to external systems outside the LAN.

8. The apparatus of claim 1, further comprising:
a configuration interface for allowing configuration of the common address for the plurality of interfaces.

9. A communication system comprising:
a first communication network comprising a gateway, the gateway comprising the apparatus of claim 1; and
a second communication network comprising the remote system, the gateway providing the second communication network with access to the first communication network.

10. The communication system of claim 9, wherein the gateway is associated with an address in the first communication network, the address being used in the first communication network for communicating traffic between the first communication network and the second communication network, wherein the common address comprises an address in the second communication network, and wherein the controller is further configured to select a new active interface from the plurality of interfaces responsive to a fault associated with the active interface or the communication path supported by the active interface, the first communication network address remaining usable for communicating traffic between the first communication network and the second communication network after the new active interface is selected.

11. A communication network gateway for providing access to a communication network from an access network, the gateway comprising:
a configuration interface for allowing configuration of a communication path redundancy group, the communication path redundancy group comprising a plurality of communication paths between the gateway and the access network, the plurality of communication paths being supported by respective communication interfaces having a common address associated with the access network; and
a controller configured to control the plurality of communication paths to designate one of the plurality of communication paths as an active communication path for transfer of communication traffic between the communication network and the access network.

12. The gateway of claim 11, wherein the common address comprises a default gateway address used by components of the access network to access the communication network.

13. The gateway of claim 11, wherein the gateway is associated with an address used in the communication network for communications with the access network.

14. The gateway of claim 13, wherein the address of the gateway is independent of the active communication path.

15. The gateway of claim 11, wherein the controller is further configured to detect a fault associated with the active communication path, and to designate another communication path of the redundancy group as the active communication path responsive to the detection.

16. A method of providing communication path redundancy in a communication system, the method comprising:
configuring, as a communication path redundancy group, a plurality of communication paths through respective communication interfaces having a common address;
selecting one of the plurality of communication paths as an active communication path for transfer of communication traffic; and
selecting another one of the plurality of communication paths as the active communication path responsive to a fault associated with the active communication path.

17. The method of claim 16, further comprising:
monitoring at least the active communication path,
wherein selecting another one of the plurality of communication paths comprises selecting another one of the plurality of communication paths responsive to a fault detected during the monitoring.

18. The method of claim 16, wherein the communication paths comprise communication paths between a communication network gateway and an access network, and wherein configuring comprises configuring as the common address a default gateway address used in the access network.

19. The method of claim 18, further comprising:
configuring a further communication interface with an address used in the communication network to transfer communication traffic to the access network, the address being unaffected by the operation of selecting another one of the plurality of communication paths.

20. A machine-readable medium-storing instructions which when executed enable the method of claim 16 to be performed, the instructions comprising instructions which when executed allow the communication path redundancy group to be configured, and instructions which when executed perform the operations of selecting one of the plurality of communication paths and selecting another one of the plurality of communication paths.
